(19) United States
(12) Patent Application Publication
(10) Pub. No.: US 2025/0006951 A1
(43) Pub. Date: Jan. 2, 2025

(54) DEVICE FOR MANAGING IMPLEMENTATION OF A LIMITATION OF THE CURRENT INTENDED TO POWER A CONNECTED OBJECT

(71) Applicant: SAFRAN ELECTRONICS & DEFENSE, Paris (FR)

(72) Inventor: Rémy Hoff, Moissy-Cramayel (FR)

(73) Assignee: SAFRAN ELECTRONICS & DEFENSE, Paris (FR)

(21) Appl. No.: 18/688,097

(22) PCT Filed: Aug. 22, 2022
(86) PCT No.: PCT/FR2022/051598

§ 371 Date: Feb. 29, 2024

(30) Foreign Application Priority Data
Sep. 3, 2021 (FR) FR2109203

(51) Int. Cl. H01M 6/50; H01M 10/44

(52) U.S. Cl. CPC H01M 6/50; H01M 10/446

(57) ABSTRACT

This device for managing implementation of a limitation of the value of a current output from non-rechargeable means for storing electrical energy that are intended to power wireless means for transmitting periodically, comprises: —computing means able to determine a current-threshold value depending on a physical quantity; —a current-limiting circuit; —rechargeable means for storing electrical energy, which are coupled to the limiting circuit and are intended to power said data-transmitting means and, —control means able to control the limiting circuit in order to make it perform, for a predetermined time, said limitation only when the value of the current is lower than the threshold value, the limiting circuit being able to deliver the limited current to the rechargeable means for storing electrical energy.

### TECHNICAL FIELD

The present invention relates generally to connected objects and relates more particularly to the regulation of the electrical current powering such objects.

### PRIOR ART

The number of connected objects, also referred to as communicating objects, is increasing considerably.

They are now being used in home automation as well as in industry.

More particularly in industry, the connected objects enable the precise geolocation of goods in transit into which they are integrated.

To achieve this, the connected object communicates remotely data which include geographical coordinates to another electronic device intended to read them.

This type of communication can be performed via local networks (WIFI, Ethernet, Bluetooth, etc.) or via large-scale networks such as the Low Power Wide Area Network (LPWAN).

This network is particularly suited to applications for connected objects because it provides a long range (several kilometres) and occasionally processes small amounts of information while maintaining low consumption of electricity.

For this reason, connected objects are generally powered by non-rechargeable means for storing electrical energy intended to last for several years.

However, the electrical power necessary for transmitting data is regulated by operators of LPWAN networks.

Certain national regulations also impose a value for the power intended to supply means for transmitting data.

For example, in the European Union, when a data frame requires 2.1 seconds to be transmitted remotely, the current has to be equal to 33 mA at 3.3 V.

However, respecting these constraints becomes problematic, particularly when the said means for storing electrical energy are faced with extreme temperatures.

More particularly, when the temperature reaches −40° C., the transmission means require a higher current for the same power because the voltage of the storage means decreases.

It is therefore proposed to use lithium iron disulphide (Li—FeS₂) batteries, which have the capacity to supply high currents and therefore meet these requirements despite the environmental constraints encountered.

However, these batteries do not have a large volumetric capacity, unlike other lithium chloride energy storage means, such as lithium thionyl chloride (Li-SOCL₂) batteries.

It would therefore have been interesting to use these storage means but it has been observed that the voltage they deliver decreases sharply even at ambient temperature.

The power intended to supply the transmission means of the connected object is therefore below the thresholds required by operators. In addition, the transmission means are inoperable at a low operating voltage (usually 2.2V).

Furthermore, in order to achieve the power required to operate the transmission means at such a voltage, the current has to reach significant values.

The effective capacity therefore degrades rapidly when data is transmitted periodically, for example two to five times a day.

It is therefore advantageous to optimise the operation of lithium thionyl chloride batteries in order to benefit from their volumetric capacity without changing it.

### Explanation of the Invention

In view of the above, one object of the invention is a method for managing the implementation of a limitation of the value of a current at the output of non-rechargeable means for storing electrical energy intended to power wireless means for the periodic transmission of data.

A value of the current threshold is determined as a function of a physical quantity, and the implementation of the limitation of the value of the current is only carried out, for a predetermined period, when the value of said current is lower than the threshold value.

The limited circuit is then delivered to rechargeable means for storing electrical energy intended to power said means for transmitting data.

In other words, when the meteorological conditions mean that there is a demand for more current than the non-rechargeable storage means can supply without affecting their performance, the value of the current at the output of the said storage means is limited so as to power the rechargeable storage means.

The rechargeable storage means then receive the current limited to a defined value for a predetermined period until they can deliver the power required to the transmission means.

The effective capacity of the non-rechargeable storage means is therefore preserved.

Advantageously, the physical quantity is the temperature of the non-rechargeable means for storing electrical energy.

As the temperature has a direct influence on the current delivered by the non-rechargeable storage means, it is possible to determine the current required in real time to achieve the power required by the transmission means.

When the current that can be delivered is lower than this threshold value, the effective capacity of the non-rechargeable energy storage means is changed in order to reach said threshold value.

It is therefore necessary to limit the current delivered under these conditions.

Another object of the invention is a device for managing the implementation of a limitation of the value of a current at the output of non-rechargeable means for storing electrical energy intended to power wireless means for periodic transmission.

The device comprises:
computing means capable of determining a threshold value of the current as a function of a physical quantity;
a current-limiting circuit;
rechargeable means for storing electrical energy coupled to the limiter circuit and intended to power said means for transmitting data and,
control means capable of controlling the limiter circuit so that, for a predetermined period, it carries out the said limitation only when the value of the current is lower than the threshold value, the limiter circuit being capable of supplying the limited current to the rechargeable means for storing electrical energy.

Advantageously, the limiter circuit comprises an adjustable current chopper.

A “chopper” is defined as a DC-DC converter, which in this case comprises a module intended to limit the current received in the converter transistor for example.

Preferably, the physical quantity is the temperature of the non-rechargeable means for storing electrical energy.

Preferably, the rechargeable means for storing electrical energy include at least one supercapacitor.

The advantage of the supercapacitor is it low internal resistance. The current it delivers is then considerably greater than non-rechargeable storage means.

Advantageously, the supercapacitor has a capacitance of between 100 mF and 500 mF, preferably approximately 330 mF, which makes it possible to restore to the communication means an energy of 690 mJ, or 33 mA at 3.3 V for 2.1 s.

The invention also relates to a connected object comprising wireless means for the periodic transmission of data, non-rechargeable means for storing electrical energy capable of powering said transmission means and, a device for managing the implementation of a limitation of the current at the output of said non-rechargeable means for storing electrical energy, as defined above.

Preferably, the transmitted data are the geographical coordinates of said object.

These can include for example the latitude and/or the longitude and/or the altitude.

Another object of the invention is a charging unit comprising at least one connected object as defined above.

More specifically, this consists of means known by the acronym ULD (Unit Load Device), the shape and the dimensions of which are suitable for transporting objects by air.

### BRIEF DESCRIPTION OF THE DRAWINGS

Other aims, features and advantages of the invention will become apparent from the following description, given solely by way of a non-limiting example, with reference to the accompanying drawings in which:

FIG. 1 represents a charging unit comprising connected object according to the invention;

FIG. 2 shows schematically the components of said connected object according to an embodiment of the invention;

FIG. 3 shows schematically the components of a device for managing the implementation of a limitation of the current intended to power the connected object and,

FIG. 4 shows a flowchart of a method for managing the implementation of the limitation of said current according to one mode of implementation of the invention.

### DETAILED DESCRIPTION OF EMBODIMENTS OF THE INVENTION

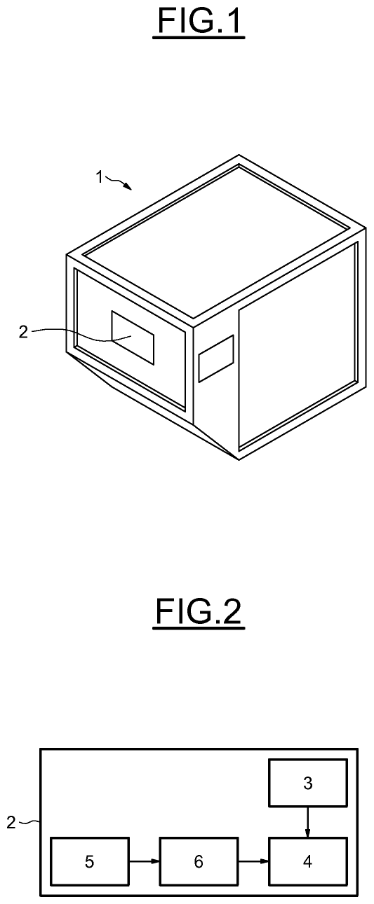

FIG. 1 shows a ULD type charging unit 1 adapted in its shape and dimensions to the air transport of goods.

In this example, the charging unit 1 is in the form a container built in such a way as to minimise the risk of damage to the goods during the various phases of the flight of the aircraft.

In order to track the route of the goods, it is advantageous to regularly locate the charging unit 1 remotely and thus detect any logistical anomalies.

To achieve this, a connected object 2 is arranged on the charging unit 1 so as to communicate data frames containing the geographical coordinates of the charging unit 1 to other devices.

To perform such a communication, the connected object 2 includes, as illustrated in FIG. 2, geolocalisation means 3 and means for the periodic transmission of data 4.

The transmission means 4 are coupled to said geolocalisation means 3 so as to acquire said geographical coordinates and then transmit them.

To this end, the transmission means 4 are powered by non-rechargeable means for storing electrical energy 5 which supply them with the energy required to send the data.

The data is then transmitted over a low power wide area network (LPWAN), characterised by its long range and lower power consumption.

However, as the charging unit 1 is intended to travel large distances, the temperature to which the connected object 2 is subjected is likely to vary between −40 and +60° C.

Its performance may then be adversely affected, particularly when the non-rechargeable means for storing electrical energy 5 are lithium thionyl chloride type batteries.

More particularly, the voltage delivered is likely to decrease sharply in these conditions, which means that these batteries 5 have to deliver a higher current to achieve the power required for the operation of the transmission means 4.

The connected object 2 then includes a device 6 for managing the implementation of a limitation of the output current of said non-rechargeable means for storing electrical energy 5.

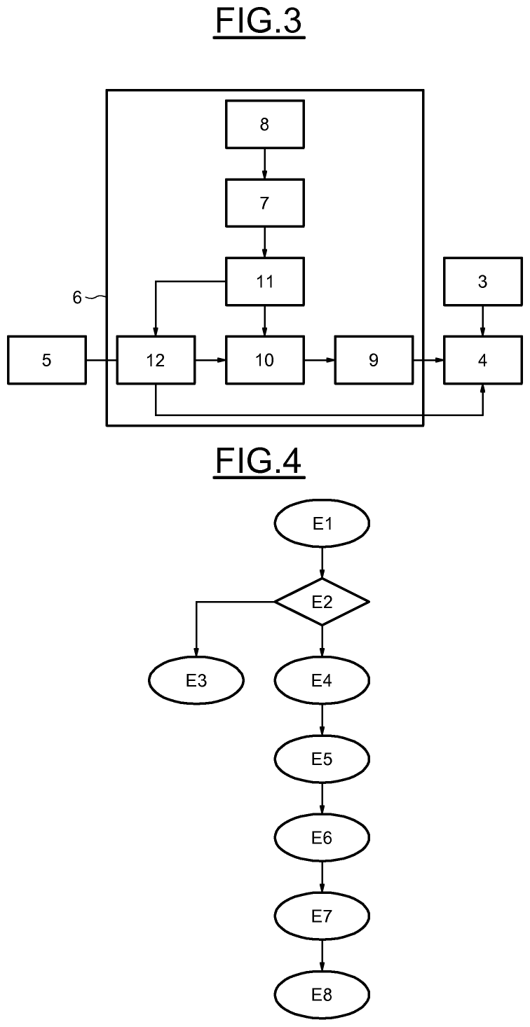

Such a device 6 includes, as shown in FIG. 3, computing means 7 capable of determining a threshold value of current as a function of the value of the temperature acquired by a temperature sensor 8.

The device 6 further includes rechargeable means for storing electrical energy 9 and a current-limiting circuit 10.

More precisely, the current-limiting circuit 10 is coupled to the rechargeable means for storing electrical energy 9 to reduce the current to a defined value.

The current-limiting circuit 10 is thus able to deliver the current to the rechargeable means for storing electrical energy 9 so that they can supply said data-transmitting means 4 once charged.

For example, the rechargeable means for storing electrical energy 9 can be in the form of at least one supercapacitor.

Due to the value of its internal resistance, the supercapacitor delivers a high current, thus achieving the power required for data transmission.

The supercapacitor can have a capacitance of 330 mF in order to store enough energy to supply the power required for the duration of the data transmission (2.1 s).

To power it, the device 6 further comprises control means 11 arranged between the computing means 7 and the current limiter 10 so as to activate the latter for a predetermined period.

The control means 11 are also capable of delivering a control signal to coupling means 12 connecting the non-rechargeable means for storing energy 5 directly to the transmission means 4.

Reference is made to FIG. 4 which illustrates the various steps of a method for managing the implementation of the limitation of the output current of non-rechargeable means for storing electrical energy 5, implemented by the device 6.

The method begins with a step E1 in which the computing means 7 periodically retrieve the temperature value to calculate the threshold value which represents the current necessary for the operation of the transmission means 4.

In step E2, the control means 11 compare the threshold value with the output current of the non-rechargeable means for storing electrical energy 5.

If the current is greater than or equal to the threshold value, the control means 11 maintain the coupling between the storage means 5 and the transmission means 4 in step E3.

In other words, the current at the output of the storage means 5 is delivered directly to the transmission means 4.

Otherwise, when the current delivered by the non-rechargeable means for storing electrical energy 5 is lower than the threshold value, said storage means 5 will attempt to deliver a current equal to the threshold value and therefore to meet the needs of the transmission means 4.

To avoid degrading the effective capacity of the non-rechargeable means for storing electrical energy 5, the control means 11 activate the current limiter 10 for the defined period in step E4.

It should be noted that said period is calculated as a function of the current at the output of the limiter 10.

This is the period necessary to charge the rechargeable means for storing electrical energy 9 so that they can deliver the power required to operate the transmission means 4 for the period of data transmission.

At the same time, the control means 11 send the control signal to the coupling means 12 to decouple the non-rechargeable means for storing electrical energy 5 from the transmission means 3.

The current limiter 10 then receives the output current from the storage means 5 and reduces it, in step E5, to preserve their capacitance.

For example, the current may be between 1 and 5 mA.

As soon as the rechargeable means for storing electrical energy 9 have the power required to operate the transmission means 4, the control means 11 deactivate the limiter 10 in step E6.

To achieve this, the control means 11 deliver the control signal to the coupling means 12 to recouple the non-rechargeable means for storing electrical energy 5 to the transmission means 4 only.

The rechargeable means for storing electrical energy 9 are therefore not permanently powered.

Then, in step E7, the means for storing electrical energy 9 discharge into the transmission means 4.

Finally, in step E8, the transmission means 4 remotely send the geographical coordinates of the processing unit 1.

1. A method for managing an implementation of a limitation of a value of a current output from non-rechargeable means for storing electrical energy intended to power wireless means for periodic transmission of data, the method comprising:
determining a current threshold value as a function of a physical quantity, wherein the implementation of the limitation of the value of the current is only carried out, for a predetermined period, when the value of the current is lower than the current threshold value; and
supplying the current to rechargeable means for storing electrical energy intended to power the wireless means to facilitate transmitting data.

2. The method according to claim 1, wherein the physical quantity is a temperature of the non-rechargeable means for storing electrical energy.

3. A device for managing implementation of a limitation of a value of a current at an output of non-rechargeable means for storing electrical energy intended to power wireless means for periodic transmission, the device comprising:
computing means for determining a threshold value of the current as a function of a physical quantity;
a current-limiting circuit;
rechargeable means for storing electrical energy, the rechargeable means coupled to the limiter circuit and intended to power the wireless means to facilitate transmitting data; and
control means for controlling the limiter circuit, wherein for a predetermined period, the control means controls the limiter circuit only when the value of the current is lower than the threshold value, the limiter circuit being configured to supply the current to the rechargeable means for storing electrical energy.

4. The device according to claim 3, wherein the limiter circuit comprises an adjustable current chopper.

5. The device according to claim 3, wherein the physical quantity is a temperature of the non-rechargeable means for storing electrical energy.

6. The device according to claim 3, wherein the rechargeable means for storing electrical energy includes at least one supercapacitor.

7. The device according to claim 6, wherein the supercapacitor has a capacitance of between 100 mF and 500 mF.

8. Connected object comprising wireless means for periodic transmission of data, non-rechargeable means for storing electrical energy capable of powering said transmission means, wherein the connected object further comprises a device for managing the implementation of a limitation of the current at the output of said non-rechargeable means for storing electrical energy according to claim 3.

9. The connected object according to claim 8, wherein the transmitted data comprise geographical coordinates of said object.

10. Charging unit comprising the connected object according to claim 8.
